(19) United States
(12) Patent Application Publication
(10) Pub. No.: US 2006/0026181 A1
(43) Pub. Date: Feb. 2, 2006

(54) Image processing systems and methods with tag-based communications protocol

(76) Inventor: Jeff Glickman, Las Vegas, VN (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/139,919

(22) Filed: May 26, 2005

Related U.S. Application Data
(60) Provisional application No. 60/575,735, filed on May 28, 2004.

(51) Int. Cl. G06F 7/00; G06F 15/16

(52) U.S. Cl. 707/100; 709/231

(57) ABSTRACT

Communications software for enabling display of images, including a communications protocol. The protocol is adapted to allow portions of image data to be encoded into selected ones of a plurality of different data structures. Each data structure has an associated tag, to facilitate parsing at a receiving location.

### CROSS-REFERENCE TO RELATED APPLICATION

The present application claims priority from U.S. Provisional Patent Application Ser. No. 60/575,735 filed May 28, 2004, hereby incorporated by reference in its entirety for all purposes.

### TECHNICAL FIELD

The present disclosure relates generally to apparatus, systems and methods for processing image data, and more specifically, to apparatus, systems and methods for providing network communications between client image source devices and targeted server display devices.

### BRIEF DESCRIPTION OF THE DRAWINGS

FIG. 1 is a schematic view of an image data processing system according to a first embodiment of the present invention.

FIG. 2 is a schematic depiction of an exemplary computing device that may be employed in connection with the software, systems and methods of the present invention.

FIG. 3 is a flow diagram of an exemplary method of processing image data according to the present invention.

FIG. 4 is a schematic depiction of an exemplary client image source device and targeted server display device communicating in accordance with present invention.

FIGS. 5-12 depict exemplary aspects of a network communications protocol that may be employed to facilitate network communications between one or more image source devices and one or more targeted display devices.

### DETAILED DESCRIPTION

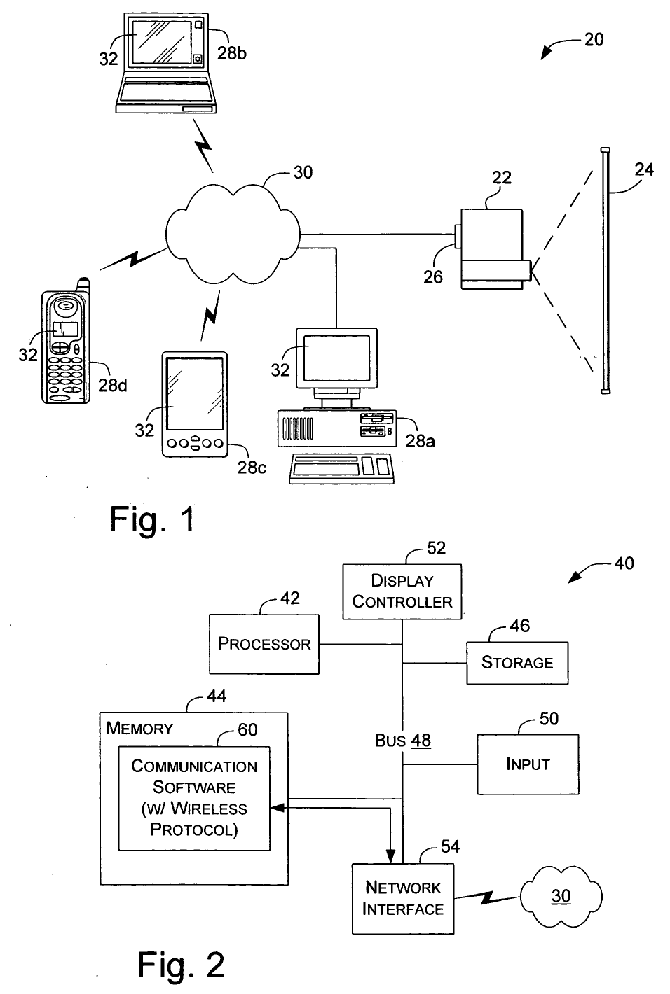

FIG. 1 shows, generally at 20, a schematic depiction of an image data processing system according to a first embodiment of the present invention. Image processing system 20 includes a display device 22 configured to display an image on a viewing surface 24. Display device 22 may be any suitable type of display device. Examples include, but are not limited to, liquid crystal display (LCD) and digital light processing (DLP) projectors, television systems, computer monitors, etc.

Image processing system 20 also includes an image-rendering device 26 associated with display device 22, and one or more image sources 28 in electrical communication via network 30 with image-rendering device 26. Image-rendering device 26 is configured to receive image data transmitted by image sources 28, and to process the received image data for display by display device 22. Image-rendering device 26 may be integrated into display device 22, or may be provided as a separate component that is connectable to the display device. An example of a suitable image-rendering device is disclosed in U.S. patent application Ser. No. 10/453,905, filed on Jun. 2, 2003, which is hereby incorporated by reference. The interconnections between the parts of system 20 may be wireless (e.g., network 30 may be a wireless network), wired, or a combination of wired and wireless links.

Typically, image data is supplied to a display device via an image source such as a laptop or desktop computer, a personal digital assistant (PDA), or other computing device. Some display devices are configured to receive image data wirelessly from image sources, for example, via a communications protocol such as 802.11b (or other 802.11 protocols), Bluetooth, etc. These display devices may allow image sources to be quickly connected from almost any location within a meeting room, and thus may facilitate the use of multiple image sources with a single display device.

However, supporting the use of multiple image sources with a single display device may pose various difficulties. For example, different image sources may utilize different software to generate and/or display image files of different formats. In this case, a display device that supports multiple image sources may need to include suitable software for decompressing, rendering and/or displaying many different types of image files. In many cases, this software may be provided by a company other than the display device manufacturer. Thus, installing and updating such software may expose the display device to software viruses, programming bugs, and other problems that are out of the control of the display device manufacturer. Furthermore, a relatively large amount of memory and processing power may be required to store and execute the multiple software programs needed to display all of the desired image data formats.

One possible way to decrease the amount of software needed on the display device may be to transfer only raw data files from each image source to the display device, rather than formatted image data files. In this case, the display device may only have to support a single image data format, which may simplify the software requirements of the display device. However, such raw data files may be large compared to formatted image files, and thus may require a relatively long time to transfer from the image source to the display device, depending upon the bandwidth of the communications channel used. Where it is desired to display real-time video with such a display device, the bandwidth of the communication channel may be too small for raw image data files to be transferred at typical video data frame rates (typically approximately 20 frames/second or greater).

Referring back to FIG. 1, image sources 28 may include any suitable device that is capable of providing image data to image-rendering device 26. Examples include, but are not limited to, desktop computers and/or servers 28a, laptop computers 28b, personal digital assistants (PDAs) 28c, mobile telephones 28d, etc. Additionally, image sources 28 may communicate electrically with image-rendering device 26 in any suitable manner. In the depicted embodiment, each image source 28 communicates electrically with image-rendering device 26 over a wireless network 30. However, image sources 28 may also communicate with image-rendering device 26 over a wired network, over a wireless or wired direct connection, etc. or any combination thereof.

Image sources 28 and/or display device 22 may be implemented as computing devices having some or all of the components shown in exemplary computing device 40 of FIG. 2. Computing device 40 includes a processor 42, memory 44 and/or storage 46 interconnected by bus 48. Various input devices 50 (e.g., keyboard, mouse, etc.) may also be connected to enable user input. Output may be provided via a monitor or other display coupled with display controller 52. As shown, a network interface 54 may also be coupled to bus 48, so as to enable communication with other devices connected to network 30. As will be discussed in more detail, in the image processing systems and methods described herein, it will often be desirable for an image source/client device (e.g., image source 28) to wirelessly communicate over a network with a server display device (e.g., display device 22). In the client and/or server devices, network communications software 60, including a wireless protocol, may run in memory 44 and operate to enable wireless network communications.

Referring again to FIG. 1, where image sources 28 are configured to process image data in multiple formats, image-rendering device 26 may be configured to decode data in each desired image data format. However, as described above, this may require image-rendering device 26 to have sufficient memory to store separate software programs for decoding each desired format. Additionally, many of these software programs may be provided by sources other than the manufacturer of image-rendering device 26. Thus, the use of such software may reduce the control the manufacturer of image-rendering device 26 has over the software programs installed on the image-rendering device 26 and/or display device 22. This may open these display devices up to viruses, bugs and other problems introduced by outside software during software installations, updates and the like.

In order to simplify the operation of and software requirements for image-rendering device 26, each image source 28 may include software configured to generate a bitmap of an image on display 32, and then to transmit the bitmap to image-rendering device 26 for display by display device 22. This offers the advantage that image-rendering device 26 needs only to include software for receiving and decoding image data of a single format, and thus helps to prevent the introduction of viruses, bugs and other problems onto image-rendering device 26 during installation of software and/or updates. However, as described above, uncompressed bitmap files may be quite large, and thus may take a relatively long time to transmit to image-rendering device 26, depending upon the bandwidth of the communications channel used. This is especially true for images in relatively high-resolution formats, such as XGA and above. Where the data is video data, the rate at which new data frames are transferred to image-rendering device 26 may be approximately 20 frames/second or greater. In this case, the frame rate may be faster than the rate at which an entire bitmap can be generated and transmitted to image-rendering device 26, possibly resulting in errors in the transmission and display of the video image.

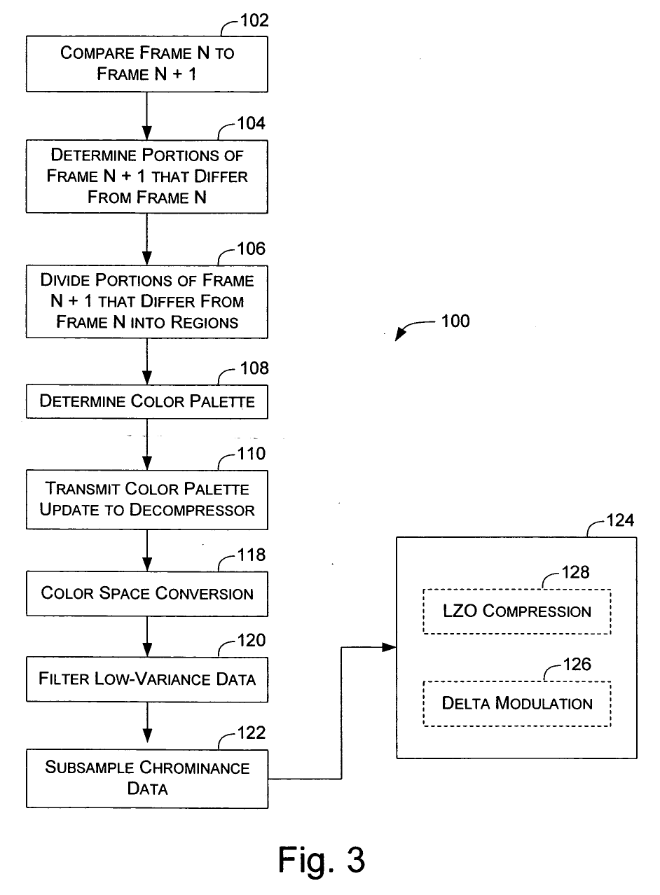

To avoid transmission and display errors, a bitmap generated from an image displayed on one of image sources 28 may be processed before transmission to reduce the amount of data transmitted for each frame of image data. FIG. 3 shows, generally at 100, an exemplary embodiment of a method of processing bitmap image data generated from a display 32 on one of image sources 28. Method 100 is typically carried out by software code, typically stored in memory on image sources 28, executable by a processor on each image source.

In order to reduce the amount of data that is transmitted to image-rendering device 26, method 100 typically transmits only those portions of a frame or set of image data that differ from the frame or set of image data transmitted immediately prior to the current frame. Thus, method 100 may first compare, at 102, a previously transmitted set or frame of image data N to a set or frame of image data N+1 that is currently displayed on display 32, and then may determine, at 104, portions of frame N+1 that differ from frame N.

The comparison of the two frames of image data at 102 and the determination of changed portions at 104 may be performed in any suitable manner. For example, each of frames N and N+1 may be stored in buffers, and then each pixel of image data stored in the N+1 buffer may be compared to each pixel of image data stored in the N buffer.

Where changes are located, the changed regions may be defined for compression in any suitable manner. For example, in some embodiments, all of the detected changes may be defined by a single rectangular region of variable size that is drawn to encompass all of the changed regions of frame N+1 of the image data. However, situations may exist in which such a scheme of defining changed portions leads to the compression and transmission of significant quantities of data that is actually unchanged from the previously sent frame.

Accordingly, as shown at 106, method 100 may include defining changed portions of image data frame N by dividing the changed portions into different regions. The regions typically are the smallest bounding rectangle that can be defined around a given changed portion of the frame, in order to minimize transmission of unchanged data.

Referring still to FIG. 3, either before, concurrently with, or after dividing the changed portions into regions, method 100 may include determining, at 108, the color palette of the image being encoded and transmitted, and transmitting, at 110, an update regarding the color palette to image-rendering device 26 to aid in the decompression of the compressed image data. This is because a 24-bit color may be abbreviated by an 8-bit lookup value in a color palette. When the color is used repeatedly, the 8-bit abbreviation results in less data to transmit. Additionally, or alternatively, it will be appreciated that a lookup table of any bit size may be employed. For example, 12 or 16 bits may be employed.

Next, the image data may be converted, at 118, to a luminance/chrominance color space. Examples of suitable luminance/chrominance color spaces include device-dependent color spaces such as the YCrCb color space, as well as device-independent color spaces such as the CIE XYZ and CIE L*a*b* color spaces. Another example of a suitable device independent color space is as follows. The color space includes a luminance r value and chrominance s and t values, and is derived from the CIE L*a*b* color space by the following equations:
r=(L*−L*ₘᵢₙ)(rₘₐₓ/(L*ₘₐₓ−L*ₘᵢₙ))
s=(a*−a*ₘᵢₙ)(sₘₐₓ/(a*ₘₐₓ−a*ₘᵢₙ))
t=(b*−b*ₘᵢₙ)(tₘₐₓ/(b*ₘₐₓ−b*ₘᵢₙ))

The r, s and t values calculated from these equations may be rounded or truncated to nearest integer values to change the format of the numbers from floating point to integer format, and thus to simplify calculations involving values in the color space. In these equations, the values L*ₘₐₓ, L*ₘᵢₙ, a*ₘₐₓ, a*ₘᵢₙ, b*ₘₐₓ and b*ₘᵢₙ may correspond to the actual limits of each of the L*, a* and b* color space coordinates, or to the maximum and minimum values of another color space, such as the color space of a selected image device 28, when mapped onto the CIE L*a*b* color space. The values rₘₐₓ, sₘₐₓ and tₘₐₓ correspond to the maximum integer value for each of the r, s and t color coordinates, and depend upon the number of bits used to specify each of the coordinates. For example, where six bits are used to express each coordinate, there are sixty-four possible integer values for each coordinate (0-63), and rₘₐₓ, sₘₐₓ and tₘₐₓ each have the value 63.

After color space conversion, low variance data may be filtered, at 120 to make non-computer graphics data (“non-CG data”) more closely resemble computer graphics data (“CG data”). Images having CG data, such as video games, digital slide presentation files, etc. tend to have sharper color boundaries with more high-frequency image data than images having non-CG data, such as movies, still photographs, etc. Due to the different characteristics of these data types at color boundaries, different compression algorithms tend to work better for CG data than for non-CG data. Some known image data processing systems attempt to determine whether data is CG data or non-CG data, and then utilize different compressors for each type of data. However, the misidentification of CG data as non-CG data, or vice versa, may lead to loss of compression efficiency in these systems. Thus, the filtering of low-variance data 120 may include identifying adjacent image data values with a variance below a preselected threshold variance, which may indicate a transition between similar colors, and then changing some of the image data values to reduce the variance, thereby creating a color boundary that more closely resembles CG data. The filtering of low-variance data may thus may allow non-CG data and CG data to be suitably compressed with the same compressor. The changes made to the non-CG data are typically made only to adjacent values with a variance below a perceptible threshold, although changes may optionally be made to values with a variance above a perceptual threshold.

Any suitable method may be used to filter low-variance data from the image data within an image data layer. One example of a suitable method is to utilize a simple notch denoising filter to smooth out the low variance data. A notch denoising filter may be implemented as follows. Let p_{c} represent a current pixel, pi a pixel to the left of the current pixel, and pᵣ a pixel to the right of the current pixel. First, the difference dₗ between p_{c} and pₗ and the difference dᵣ between p_{c} and pᵣ are calculated. Next, dₗ and dᵣ are compared. If the absolute values of dₗ and dᵣ are not equal, and the absolute value of the lower of dₗ and dᵣ is below a preselected perceptual threshold, then p_{c} may be reset to be equal to pₗ or pᵣ to change the lower of dₗ and dᵣ to zero. Alternately, either of pₗ and pᵣ may be changed to equal p_{c} to achieve the same result.

If the absolute values of dₗ and dᵣ are equal, then changing p_{c} to equal pₗ may be equivalent to changing p_{c} to equal pᵣ. In this case, if the absolute value of dₗ and dᵣ is below the predetermined perceptual threshold, then p_{c} may be changed to equal either of pₗ and pᵣ. Furthermore, if the absolute values of dₗ and dᵣ are both above the preselected perceptual threshold, then none of p_{c}, pₗ, or pᵣ is changed. It will be appreciated that the above-described filtering method is merely exemplary, and that other suitable methods of filtering low-variance data to make non-CG more closely resemble CG data may be used. For example, where the absolute values of dₗ and dᵣ are equal and below the preselected perceptual threshold, decision functions may be employed to determine whether to change a current pixel to match an adjacent pixel on the right or on the left, or above or below.

Besides filtering low-variance data to make non-CG data more closely resemble CG data, method 100 may also include, at 122, subsampling the chrominance values of the image data. Generally, chroma subsampling is a compression technique involves sampling at least one color space component at a lower spatial frequency than at least one other color space component. The decompressing device recalculates the missing components. Common subsampled data formats for luminance/chrominance color spaces include 4:2:2 subsampling, where the chrominance components are sampled at one half the spatial frequency of the luminance component in a horizontal direction and at the same spatial frequency in a vertical direction; and 4:2:0 subsampling, wherein the chrominance components are sampled at one half the spatial frequency of the luminance component along both vertical and horizontal directions. Either of these subsampling formats, or any other suitable subsampling format, may be used to subsample the chrominance components of the image data.

After filtering low variance data at 120 and subsampling the chrominance data at 122, method 100 next employs, at 124, one or more other compression techniques to further reduce the amount of data transmitted. Typically, compression methods that provide good compression for CG data are utilized. In the depicted example, method 100 employs a delta modulation compression step at 126, and an LZO compression step at 128. LZO is a real-time, portable, lossless, data compression method that favors speed over compression ratio, and is particularly suited for the real-time compression of CG data. LZO offers other advantages as well. For example, minimal memory is required for LZO decompression, and only 64 kilobytes of memory are required for compression.

Once the image data has been acquired from the source device (e.g., device 28) and compressed, the compressed data may be transmitted to image-rendering-device 26. In the transmission of video data, image data representing the selected frame may be larger than the maximum amount of data that can be transmitted across the communications channel during a frame interval. In this case, image sources 28 may be configured to transmit only as much data as can be sent for one frame of image data before compression and transmission of the next frame begins.

The transmitted image data is received at image-rendering device and processed for display on viewing surface 24 by display device 22. Various features may be implemented in the decompression process that help to improve decompression performance, and thus to improve the performance of the display device 22 and image-rendering device 26 when showing video images. For example, to aid in the decompression of subsampled image data, image-rendering device 26 may include a decompression buffer for storing image data during decompression that is smaller than a cache memory associated with the processor performing the decompression calculations.

Known decompression systems for decompressing subsampled image data typically read an entire set of compressed image data into a decompression buffer before calculating the missing chrominance values. Often, the compressed image data is copied into a cache memory as it is read into the buffer, which allows the values stored in cache to be more quickly accessed for decompression calculations. However, because the size of a compressed image file may be larger than the cache memory, some image data in the cache memory may be overwritten by other image data as the compressed image data is copied into the buffer. The overwriting of image data in the cache memory may cause cache misses when the processor that is decompressing the image data looks for the overwritten data in the cache memory. The occurrence of too many cache memories may slow down image decompression to a detrimental extent.

The use of a decompression buffer that is smaller than cache memory may help to avoid the occurrence of cache misses. Because cache memory is typically a relatively small memory, such a decompression buffer may also be smaller than most image files. In other words, where the image data represents an image having an A×B array of pixels, the decompression buffer may be configured to hold an A×C array of image data, wherein C is less than B. Such a buffer may be used to decompress a set of subsampled image data by reading the set of subsampled image data into the buffer and cache memory as a series of smaller subsets of image data. Each subset of image data may be decompressed and output from the buffer before a new subset of the compressed image data is read into the decompression buffer. Because the decompression buffer is smaller than the cache memory, it is less likely that any image data in the cache memory will be overwritten while being used for decompression calculations.

The decompression buffer may have any suitable size. Generally, the smaller the decompression buffer is relative to the cache memory, the lower the likelihood of the occurrence of significant numbers of cache misses. Furthermore, the type of subsampled image data to be decompressed in the decompression buffer and the types of calculations used to decompress the compressed image data may influence the size of the decompression buffer. For example, the missing chrominance components in 4:2:0 image data may be calculated differently depending upon whether the subsampled chrominance values are co-sited or non-co-sited. Co-sited chrominance values are positioned at the same physical location on an image as selected luminance values, while non-co-sited chrominance values are positioned interstitially between several associated luminance values. The missing chrominance values of 4:2:0 co-sited image data may be calculated from subsampled chrominance values either on the same line as the missing values, or on adjacent lines, depending upon the physical location of the missing chrominance value being calculated. Thus, a decompression buffer for decompressing 4:2:0 co-sited image data, which has lines of data having no chrominance values, may be configured to hold more than one line of image data to allow missing chrominance values to be calculated from vertically adjacent chrominance values.

Any suitable method may be used to determine how much image data may be sent from image sources 28 to image-rendering device 26 during a single frame interval. For example, a simple method may be to detect when a frame of image data on an actively transmitting image source 28 is changed, and use the detected change as a trigger to begin a new compression and transmission process. In this manner, transmission of image data would proceed until a change is detected in the image displayed on the selected image source, at which time transmission of data for a prior image frame, if not yet completed, would cease.

Another example of a suitable method of determining how much image data may be sent during a single frame interval includes determining a bandwidth of the communications channel, and then calculating, from the detected bandwidth and the known frame rate of the image data, how much image data can be sent across the communications channel during a single frame interval. The bandwidth may be determined either once before or during transmission of the compressed image data, or may be detected and updated periodically.

Software implementing the various compression and transmission operations of the above methods may operate as a single thread, a single process, or may operate as multiple threads or multiple processes, or any combination thereof. A multi-threaded or multi-process approach may allow the resources of system 20, such as the transmission bandwidth, to be utilized more efficiently than with a single-threaded or single process approach. The various operations may be implemented by any suitable number of different threads or processes. For example, in one embodiment, three separate threads may be used to perform the operations of above exemplary methods. These threads may be referred to as the Receiver, Processor and Sender. The Receiver thread may obtain bitmap data generated from images on the screens of image sources 28. The Processor thread may perform the comparing, region-splitting, color-space conversion and other compression steps of method 100. The Sender thread may perform the bandwidth monitoring and transmission steps discussed above. It will be appreciated that this is merely an exemplary software architecture, and that any other suitable software architecture may be used.

To display images, image processing system 20 is configured to enable communication between the client devices (e.g., image sources 28) and server devices (e.g., display device 22). In the examples described herein, the clients and servers are distinct devices, though it will be appreciated that a client and server may reside on the same computer. To facilitate client-server communication, image sources 28 and/or display device 22 may be provided with network communications software 60 (FIG. 2). As shown in FIG. 2, communications software 60 may be configured to run in memory 44 of the client or server computing device.

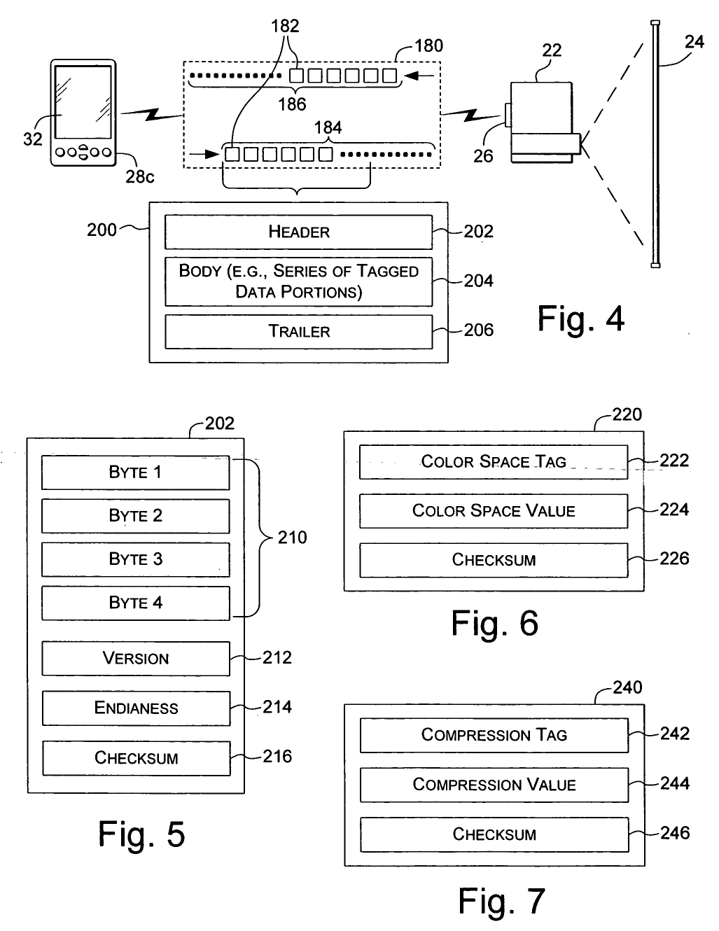

Typically, communications software 60 includes or employs a communications protocol for facilitating transfer of image data to enable display of images at display device 22. The protocol may consist of a stream 180 of bytes 182 sent between the client (e.g., image source 28) and the server (display device 22), as shown in FIG. 4, including a forward channel 184 sent from the client to the server, and a reverse channel 186 sent from the server to the client. Flow control typically is implemented via reverse channel 186. Typically, the software and protocol provide scalability and support multiple, simultaneous client connections. Therefore, there may be multiple forward and reverse channel pairs open and active simultaneously.

The forward channel is sent by the client computer to the server projector. The reverse channel is sent by the server projector back to the client computer. Typically, the communications protocol consists of data organized into frames 200, as shown in FIG. 4. In the forward channel, each frame 200 may include a header 202, body 204 and trailer 206.

Body 204 typically consists of a series of 1 to n tagged data portions encoded using selected data structures, as described below. Typical usage of the communications protocol involves a one-time transmission of header 202 at the start of connection (e.g., a TCP/IP connection), followed by a stream of tagged data portions. Trailer 206 may or may not be employed in all implementations, though in some cases use of a trailer may be desirable to perform various tasks during termination of a client-server connection.

The protocol may incorporate checksums at the end of each header and/or at the end of some or all of the tagged body data portions. Typically, the checksum is employed to detect programmatic logic errors, while transport errors typically are detected through some other mechanism. When employed, the checksum may appear as the last (n^{th}) byte of a block. The checksum may be defined as the modulo-256 sum of the previous n-1 bytes of the block of data.

Header 202 typically contains data sent from the client to the server at the start of the connection. As shown in FIG. 5, the header may consist of a 4-byte unsigned identifier 210, which may or may not be unique to the respective client device. In certain implementations, identifier 210, which may also be referred to as a magic number, identifies or validates the respective client device as a valid connector to the target server device. For example, the byte stream sent from client device 28c (FIG. 1) to server device 26 may include such an identifier 210, signifying to server device 26 that client device was a valid user of server device 26.

Header 202 may also include a version field 212, which may be used to specify the protocol version being employed for the client-server communications. Header 202 may further include an endianess field 214 to indicate endianess or other platform- or architecture-determined characteristics of the connecting client device. For example, in protocol implementations containing a declaration of endianess, field 214 may indicate that the architecture of the connecting device stores least significant values of a multi-byte sequence in the lowest memory address (“little endian”), or, alternatively, stores the most significant values in the lowest memory address (“big endian”). Bi-endian architectures may also be indicated. Use of field 214 may increase the ability of image processing system 20 to accommodate and achieve interoperability among multiple connecting client devices having diverse architectures.

Despite the ability of the protocol and target server device to handle devices with different endianess, it may in some cases be desirable to maintain a consistent byte order for identifier 210. For example, identifier 210 may be written to the output stream as four individual unsigned bytes, rather than as a 32-bit unsigned integer.

Body 204 typically takes the form of a byte stream including some or all of the following: (1) colorspace information; (2) compression information; (3) bitmap information; (4) markup language commands; (5) resolution information; (6) acknowledgement of reverse channel communications; and (7) termination information. In typical implementations, the described communications protocol is stateless, such that components of the body section may be sent in any order. It will often be desirable, however, for colorspace information to be sent at the beginning of the body transmission.

The described exemplary protocol includes a tag-based architecture, in which identifying tags are associated with particular data structures to facilitate parsing at a receiving location. This enables the protocol to be very efficient, and allows image sources (e.g., client devices) to send less data than would otherwise be required for image display at the target. For example, in contrast to a fixed format in which redundant information is repeatedly sent to the server display device (e.g., colorspace information), the tag architecture allows information to be sent only as needed.

Specifically, the protocol includes or defines a plurality of different data structures (e.g., a bitmap data structure, compression structure, etc. as discussed below). Each of the different data structures has a unique identifying tag that is associated with the data structure, to enable the target to efficiently parse the received data while using a minimum amount of processing resources. For example, bitmap information is encoded into a bitmap data structure having an associated bitmap tag. The presence of the bitmap tag and other tags in a received data stream enables a target location to efficiently parse the receive data.

FIG. 6 depicts an exemplary byte stream portion containing colorspace information encoded within a colorspace data structure 220. As shown in the figure, the initial byte (or bit or bits) may include a colorspace tag 222 identifying the byte stream portion as containing colorspace information. The colorspace employed for the subsequent forward channel content (e.g., image bitmap information) is indicated by byte or portion 224. Any desirable colorspace may be employed, including RGB (raw); YCbCr 4:4:4 Co-Sited; YCbCr 4:2:2 Co-Sited (DVCPRO50, Digital Betacam, Digital S); YCbCr 4:1:1 Co-Sited (YUV12) (480-Line DV, 480-Line DVCAM, DVCPRO); YCbCr 4:2:0 (H.261, H.263, MPEG 1); YCbCr 4:2:0 (MPEG 2); and YCbCr 4:2:0 Co-Sited (576-Line DV, DVCAM). The colorspace information may be suffixed with checksum 226 to provide error checking.

FIG. 7 depicts an exemplary byte stream segment containing compression information encoded within a compression data structure 240. The compression information typically describes how the transmitted image information is or has been compressed. As shown in the figure, the data structure may include a compression tag 242 identifying the byte stream portion as containing compression information. The compression method employed is indicated by byte or portion 244. Any desirable compression technique or algorithm may be employed, including LZ compression and/or other methods. Also, portion 244 may be used to indicate that the data is not compressed. As in other portions of the protocol, a checksum 246 may be employed to provide error checking on the compression information.

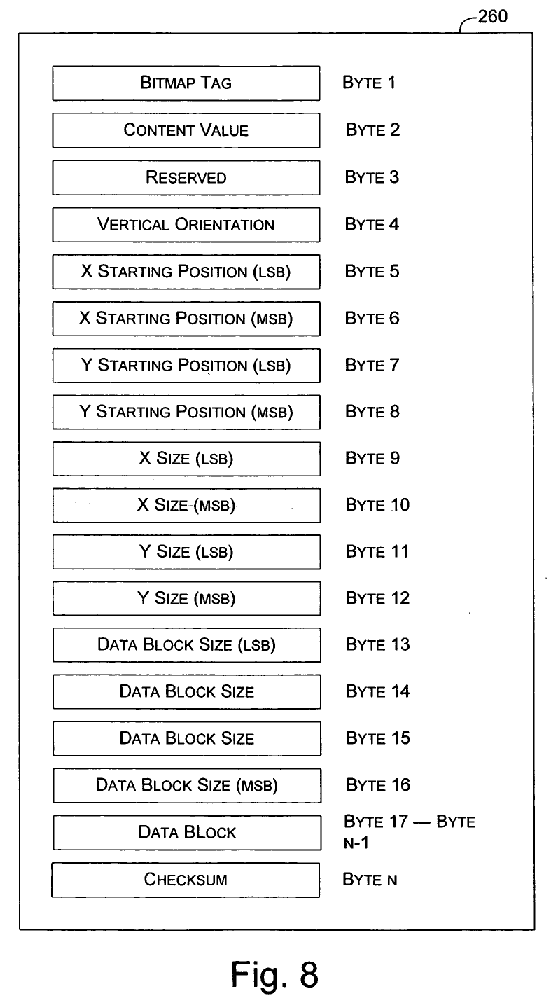

Typically, the body section of the forward channel will also include multiple bytes of bitmap information corresponding to images to be displayed at target server device 26, as shown in FIG. 8. Each portion of the bitmap information may be encoded within a bitmap structure 260. Structure 260 may include a bitmap tag (Byte 1) identifying the data stream segment as containing bitmap information. A content value (Byte 2) byte or field may be included to indicate whether the reconstituted bitmap is to be copied to the screen using a bit block transfer (BLT) (raw) or using an XOR BLT (incremental). Also, as shown, bitmap structure 260 may be defined to include data pertaining to the vertical orientation of the bitmap, the size and starting location of the bitmap (using an X-Y rectilinear coordinate scheme), the size of the data block, and the actual data block. Typically, a checksum will be employed at the end of the data block.

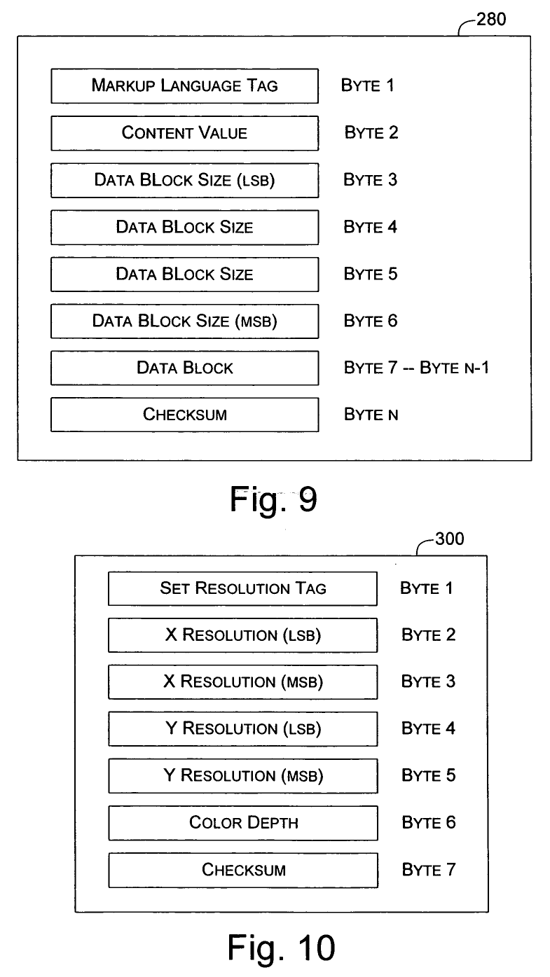

Body section 204 may also include other commands or information sent in various formats, including commands/information sent in a markup language, such as HTML or XML. FIG. 9 depicts an example of a datastream portion encoded in a markup structure 280. As shown in the figure, the encoded datastream portion may include, similar to other components of body section 204, an initial tag identifying the nature of the datastream portion (Byte 1) and a suffixed checksum (Byte n) for error correction. A content value byte (Byte 2) may be used to specify the markup language being used (HTML, XML, etc.), and subsequent bytes may be employed to specify the size of the markup language transmission, and to transmit the actual markup language information.

As shown in FIG. 10, the body of the forward channel may also include bytes used to specify a resolution to be used at the target server device. As indicated, set resolution information (e.g., encoded within set resolution data structure 300) may include an initial identifying tag, followed by bytes specifying X and Y resolution, color depth, and a checksum for error correction.

The forward channel may include other information or data for facilitating interaction between the client and server device. Bytestream segments may be used to request restart of the server, to acknowledge set scale commands sent by the server on reverse channel 186, and/or to send a termination request. A trailer 206 may be employed to perform various tasks associated with terminating the connection or with the end of a certain portion of the data transmission.

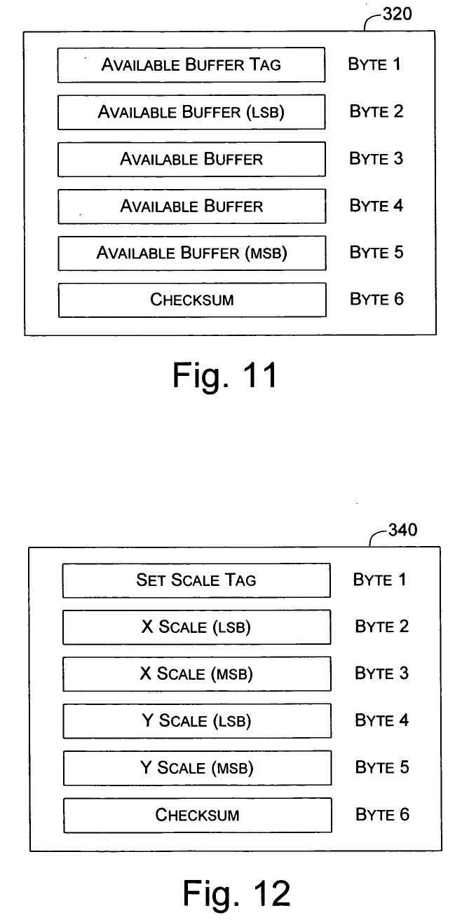

Reverse channel 186 may be employed to provide flow control and other functionality. Typically, reverse channel 186 will use a frame format similar to the forward channel (e.g., with header, body and trailer sections). Flow control may be implemented by the server periodically (e.g., ten times a second) reporting the size of the available server buffer. The reported buffer size typically is preceded by an identifying tag which indicates that the subsequent bytes contain information about buffer size, as shown in the exemplary buffer size stream 320 of FIG. 11. Then, the available buffer size is reported. In the present exemplary embodiment, the buffer size is reported in a stream of four bytes, and then a suffixed checksum byte provides error checking. The reported available buffer may then be used by the client to dynamically adjust its transmission rate in forward channel 184.

Reverse channel 186 may also include a set scale bytestream segment 340, as shown in FIG. 12. Following an identifying tag, four bytes may be employed to specify scale in X and Y dimensions. A checksum byte is again employed to provide error checking. Reverse channel communication may also include requests by the server to terminate a particular client device or connection.

Furthermore, although the present disclosure includes specific embodiments, specific embodiments are not to be considered in a limiting sense, because numerous variations are possible. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. An image display system, comprising:
a communications protocol configured to enable transmission of image data from an image source to a server, so as to cause display of images based on the image data, the communications protocol including:
a plurality of different data structures, where the plurality of different data structures includes a bitmap structure defined to include bitmap information; and
a plurality of different tags,
where the communications protocol is adapted so that client-server communications using the communications protocol occur as a serial datastream, the serial datastream including data portions encoded using selected data structures from the plurality of different data structures,
and where each of the plurality of different tags is associated with and corresponds to a particular one of the plurality of different data structures, so as to enable parsing of the serial datastream at a destination.

2. The system of claim 1, where the plurality of different data structures includes a colorspace structure defined to include colorspace information.

3. The system of claim 1, where the plurality of different data structures includes a compression structure defined to include compression information.

4. The system of claim 1, where the plurality of different data structures includes a markup structure defined to include markup information.

5. The system of claim 1, where the plurality of different data structures includes a set resolution structure defined to include set resolution information.

6. The system of claim 5, where the communications protocol includes a reverse channel adapted to provide negotiation of resolution between the image source and the server.

7. The system of claim 1, where the communications protocol is configured to enable bidirectional client-server communications to provide flow control over the transmission of image data to the server.

8. The system of claim 1, where the communications protocol includes a forward channel in which data flows toward the server and a reverse channel in which data flows toward the image source.

9. The system of claim 8, where the reverse channel is adapted to enable negotiation of resolution between the image source and the server.

10. The system of claim 8, where the reverse channel is adapted to provide flow control over transmission of image data to the server.

11. The system of claim 10, where available buffer size is reported by the server in the reverse channel.

12. A method of communicating between an image source and a server so as to cause display of images based on transmission of image data, the method comprising:
encoding image data, where encoding the image data includes encoding portions of the image data into selected ones of a plurality of different data structures, each of the plurality of different data structures having an associated tag;
transmitting encoded image data in a serial datastream to the server; and
at the server, parsing the serial datastream by receiving and processing tags present in the serial datastream.

13. The method of claim 12, where encoding the image data includes encoding bitmap information into a bitmap data structure having a bitmap tag.

14. The method of claim 12, where encoding the image data includes encoding colorspace information into a colorspace data structure having a colorspace tag.

15. The method of claim 12, where encoding the image data includes encoding compression information into a compression data structure having a compression tag.

16. The method of claim 12, where encoding the image data includes encoding markup information into a markup data structure having a markup tag.

17. The method of claim 12, where encoding the image data includes encoding set resolution information into a set resolution data structure having a set resolution tag.

18. The method of claim 12, further comprising communicating buffer information from the server in a reverse channel to the image source, to provide flow control over data transmission to the server.

19. The method of claim 18, further comprising using a forward channel and the reverse channel to negotiate display resolution between the image source and the server.

20. The method of claim 12, further comprising transmitting an endianness specification of the image source to the server.

21. The method of claim 12, further comprising transmitting a validation identifier to the server prior to transmitting the encoded image data, the validation identifier being configured to validate the image source as a valid connector to the server

22. The method of claim 12, further comprising dynamically varying transmission rate in a forward channel to the server based on available buffer size information reported from the server in a reverse channel.

23. An image display system, comprising:
a client configured to communicate with a server to cause display of images by an image display device coupled with the server, the client including communications software adapted to:
encode image data obtained from an image source, portions of the image data being encoded into selected ones of a plurality of different data structures, each of the plurality of different data structures having an associated tag; and
transmit encoded image data in a serial datastream to a target location.

24. The system of claim 23, where the plurality of different data structures includes a bitmap structure defined to include bitmap information.

25. The system of claim 23, where the plurality of different data structures includes a colorspace structure defined to include colorspace information.

26. The system of claim 23, where the plurality of different data structures includes a compression structure defined to include compression information.

27. The system of claim 23, where the plurality of different data structures includes a markup structure defined to include markup information.

28. The system of claim 23, where the plurality of different data structures includes a set resolution structure defined to include set resolution information.

29. The system of claim 23, where the client communications software is further adapted to dynamically vary transmission rate in a forward communications channel in response to available buffer size information received via a reverse communications channel.

30. An image data processing system for enabling a client image source to communicate with a targeted image display device, comprising:
client software configured to acquire source image data and generate a corresponding bitmap representation; and
communications software configured to provide communication between the client image source and the targeted image display device in the form of a bidirectional byte stream including tags configured to enable the client image source and targeted image display device to parse the byte stream.

31. The system of claim 30, where the communications software is further configured to transmit a validation identifier and the bitmap representation to the targeted image display device, the validation identifier being configured to identify the client image source as a valid connector to the targeted image display device.
